(19) United States
(12) Patent Application Publication
(10) Pub. No.: US 2026/0072153 A1
(43) Pub. Date: Mar. 12, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Yukihiro YANO, Tokyo (JP); Takahiro KUMURA, Tokyo (JP); Kosuke KINOSHITA, Tokyo (JP)

(73) Assignee: NEC Corporation, Tokyo (JP)

(21) Appl. No.: 19/311,176

(22) Filed: Aug. 27, 2025

(30) Foreign Application Priority Data
Sep. 9, 2024 (JP) 2024-154795

(51) Int. Cl. G01S 13/42; G01S 13/88

(52) U.S. Cl. CPC G01S 13/42; G01S 13/88

(57) ABSTRACT

An information processing apparatus acquires irradiation direction phase difference data indicating a displacement amount in an irradiation direction of an object, calculates a phase difference in a first direction by using a time-series temperature change in the object and a time-series temperature difference parameter and calculates a projection value of the calculated phase difference in the irradiation direction, calculates a phase difference in a second direction by using a spatial temperature difference generated in the second direction and a spatial temperature difference parameter and calculates a projection value of the calculated phase difference in the irradiation direction, and a evaluates the time-series temperature difference parameter and the spatial temperature difference parameter by using a difference between a displacement amount estimated from the two calculated projection values and a displacement amount indicated by the irradiation direction phase difference data.

This application is based upon and claims the benefit of priority from Japanese Patent Application No. 2024-154795, filed on Sep. 9, 2024, the disclosure of which is incorporated herein in its entirety by reference.

### TECHNICAL FIELD

The present disclosure relates to an information processing apparatus and an information processing method for calculating a displacement of an object, and further relates to a computer-readable recording medium in which a program for achieving the information processing apparatus and the information processing method is recorded.

### BACKGROUND ART

In general, an infrastructure such as a bridge has a lifetime, and in recent years, aging of many infrastructures has become a major social problem. In the maintenance and management of such an infrastructure, periodic inspection is important, and the inspection is usually performed manually. However, since there is a limit in manual inspection due to the problem of labor shortage, monitoring techniques using various sensors have attracted attention.

For example, for a bridge, bridge displacement analysis using a satellite synthetic aperture radar (SAR) has been proposed (for example, Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000). In bridge displacement analysis using the satellite SAR, radio waves are emitted from an artificial satellite toward a bridge at a set interval, and reflected waves are received. Then, the phase difference between the reflected waves is calculated by the interference processing. This phase difference is caused by displacement generated on the bridge during the irradiation interval of the radio wave. Then, the phase difference is converted into displacement using the wavelength of the radio wave.

This phase difference changes under the influence of the temperature of the bridge, the elapsed time of radio wave irradiation, and the topography of the place where the bridge is installed. Therefore, “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000) proposes PS (Persistent Scatterer)-InSAR analysis as a parameter estimation technique.

In the PS-InSAR analysis, in one of the interference SAR time series analysis, a point called a PS point where the reflected wave of the microwave is temporally stable is focused, and the time series change of the PS point is estimated. Specifically, in the PS-InSAR analysis, the phase difference Δφ is expressed by the following Expression 1.

$$Δ ϕ = \frac{4 π}{λ} {k}_{LOS} Δ {T}_{a i r} + \frac{4 π}{λ} {v}_{LOS} Δ t + \frac{4 π}{λ} \frac{B}{{R}_{0} sin θ} Δ h + {Δφ}_{n o i s e} \qquad [ Math . 1 ]$$

In Expression 1 above, kₗₒₛ is a parameter proportional to the temperature ΔTₐᵢᵣ of the object, and vₗₒₛ is a parameter proportional to the elapsed time Δt after the object is irradiated with the radio wave. In the above Expression 1, λ represents the wavelength of the radio wave emitted from the satellite, and B represents the baseline length (error of the orbit of the satellite). R₀ represents a strut range, that is, a distance between a satellite and an object. Δₕ represents an error between digital elevation model (DEM) data and the actual ground surface height. θ represents an angle formed between the line-of-sight direction of the artificial satellite and the vertical direction on the zx plane. Δφₙₒᵢₛₑ indicates observation noise included in the observation value.
Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000.
Monserrat, O., Crosetto, M., Cuevas, M., Crippa, B., 2011. The thermal expansion component of persistent scatterer interferometry observations. IEEE Geosci. Remote Sens. Lett. 8 (5), 864-868.

### SUMMARY

Meanwhile, in the PS-InSAR analysis disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000), a parameter proportional to the temperature is estimated on the assumption that the spatial temperature change of the object is uniform (overall temperature uniform assumption). However, for example, in a water pipe bridge for conveying water, the behavior of thermal expansion and thermal contraction may be different between the bridge axial direction and the vertical direction due to a difference in temperature of each member. That is, in a case where the member constituting the object has a thickness, when the object holds a substance other than air inside, an event in which the temperature distribution of the object is not uniform occurs.

For this reason, in the PS-InSAR analysis based on the overall temperature uniform assumption disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000) described above, there is a problem that a parameter proportional to the temperature cannot be accurately estimated for an object having a non-uniform temperature distribution. As a result, the accuracy of the displacement calculated using the parameter deteriorates in the object in which the temperature distribution is not uniform.

An object of the present disclosure is to improve calculation accuracy of displacement in an object.

In order to achieve the above object, an information processing apparatus according to an aspect of the present disclosure includes:
a data acquisition unit that acquires irradiation direction phase difference data indicating a displacement amount in an irradiation direction of an object, the displacement amount being generated by irradiation of the object with a radio wave from a flying object;
a first phase difference calculation unit that calculates a phase difference in a first direction in the object by using a time-series temperature change in the object and a time-series temperature difference parameter, and further calculates a value when the calculated phase difference in the first direction is projected in the irradiation direction;
a second phase difference calculation unit that calculates a phase difference in the second direction by using a spatial temperature difference generated in a second direction different from the first direction in the object and a spatial temperature difference parameter, and calculates a value when the calculated phase difference in the second direction is projected in the irradiation direction; and
a parameter evaluation unit that evaluates the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

In order to achieve the above object, an information processing method according to an aspect of the present disclosure includes:
a data acquisition step of acquiring irradiation direction phase difference data indicating a displacement amount in an irradiation direction of an object, the displacement amount being generated by irradiation of the object with a radio wave from a flying object;
a first phase difference calculation step of calculating a phase difference in a first direction in the object by using a time-series temperature change in the object and a time-series temperature difference parameter, and further calculating a value when the calculated phase difference in the first direction is projected in the irradiation direction;
a second phase difference calculation step of calculating a phase difference in the second direction by using a spatial temperature difference generated in a second direction different from the first direction in the object and a spatial temperature difference parameter, and calculating a value when the calculated phase difference in the second direction is projected in the irradiation direction; and
a parameter evaluation step of evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

Furthermore, in order to achieve the above object, a computer-readable recording medium according to an aspect of the present disclosure has stored therein a program containing commands for causing a computer to execute:
a data acquisition step of acquiring irradiation direction phase difference data indicating a displacement amount in an irradiation direction of an object, the displacement amount being generated by irradiation of the object with a radio wave from a flying object;
a first phase difference calculation step of calculating a phase difference in a first direction in the object by using a time-series temperature change in the object and a time-series temperature difference parameter, and further calculating a value when the calculated phase difference in the first direction is projected in the irradiation direction;
a second phase difference calculation step of calculating a phase difference in the second direction by using a spatial temperature difference generated in a second direction different from the first direction in the object and a spatial temperature difference parameter, and calculating a value when the calculated phase difference in the second direction is projected in the irradiation direction; and
a parameter evaluation step of evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

As described above, according to the present disclosure, it is possible to improve the calculation accuracy of the displacement in the object.

### BRIEF DESCRIPTION OF THE DRAWINGS

FIG. 1 is a configuration diagram illustrating a schematic configuration of an example of an information processing apparatus;

FIG. 2 is a configuration diagram specifically illustrating a configuration of an example of an information processing apparatus;

FIG. 3 is a diagram illustrating an example of an object;

FIG. 4 is a diagram illustrating displacement of an object at a reflection point relevant to irradiation direction phase difference data;

FIG. 5 is a diagram illustrating an example of irradiation direction displacement (LOS displacement) measured by an artificial satellite;

FIG. 6 is a flowchart illustrating an example of the operation of the information processing apparatus; and

FIG. 7 is a block diagram illustrating an example of a computer that achieves the information processing apparatus.

### EXAMPLE EMBODIMENT

### Example Embodiment

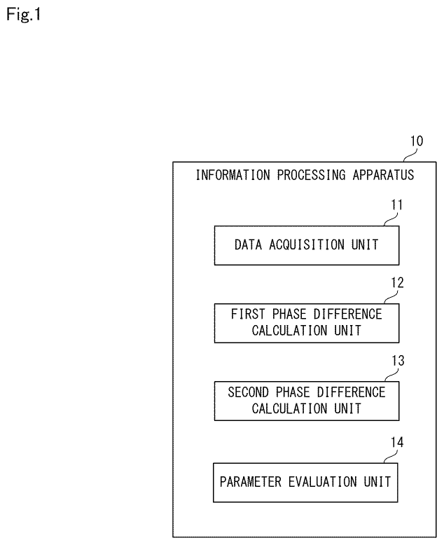

Hereinafter, in example embodiments, an information processing apparatus, an information processing method, and a program will be described with reference to FIGS. 1 to 7.

### Apparatus Configuration

First, a schematic configuration of an example of the information processing apparatus will be described with reference to FIG. 1. FIG. 1 is a configuration diagram illustrating a schematic configuration of an example of the information processing apparatus.

An information processing apparatus 10 illustrated in FIG. 1 is an apparatus used for calculating a displacement of an object. As illustrated in FIG. 1, the information processing apparatus 10 includes a data acquisition unit 11, a first phase difference calculation unit 12, a second phase difference calculation unit 13, and a parameter evaluation unit 14.

The data acquisition unit 11 acquires irradiation direction phase difference data indicating a displacement amount in the irradiation direction of the object generated by irradiation of the object with the radio wave from the flying object.

The first phase difference calculation unit 12 calculates the phase difference in the first direction in the object using the time-series temperature change in the object and the time-series temperature difference parameter. Furthermore, the first phase difference calculation unit 12 calculates a value (hereinafter, it is referred to as a “first irradiation direction projection value”) when the calculated phase difference in the first direction is projected in the irradiation direction.

The second phase difference calculation unit 13 calculates the phase difference in the second direction using the spatial temperature difference and the spatial temperature difference parameter generated in the second direction different from the first direction in the object. Furthermore, the second phase difference calculation unit 13 calculates a value (hereinafter, it is referred to as a “second irradiation direction projection value”) when the calculated phase difference in the second direction is projected in the irradiation direction.

The parameter evaluation unit 14 evaluates the time-series temperature difference parameter and the spatial temperature difference parameter using a difference obtained by subtracting the displacement amount indicated by the irradiation direction phase difference data from the displacement amount estimated using the first irradiation direction projection value and the second irradiation direction projection value.

As described above, the information processing apparatus 10 evaluates these two parameters by using the spatial temperature difference parameter proportional to the spatial temperature difference of the object in addition to the time-series temperature difference parameter proportional to the temperature of the object as the parameter regarding the temperature. Therefore, by performing the PS-InSAR analysis using the information processing apparatus 10, the displacement in the object can be calculated with high accuracy. According to the information processing apparatus 10, it is possible to improve the calculation accuracy of the displacement in the object.

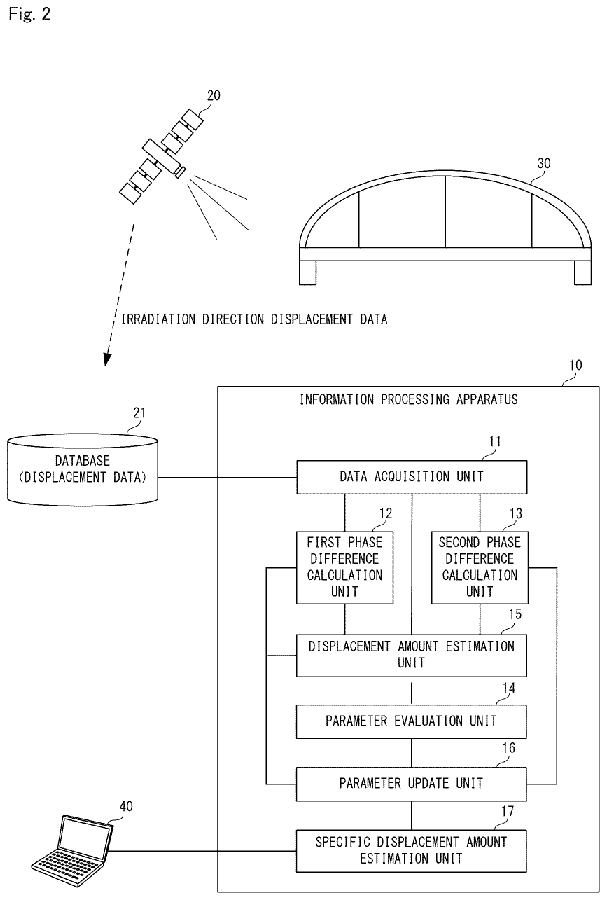

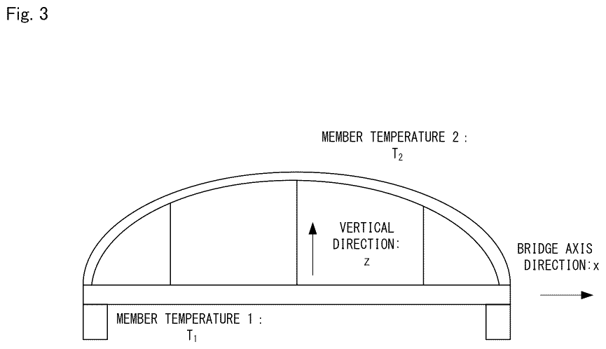

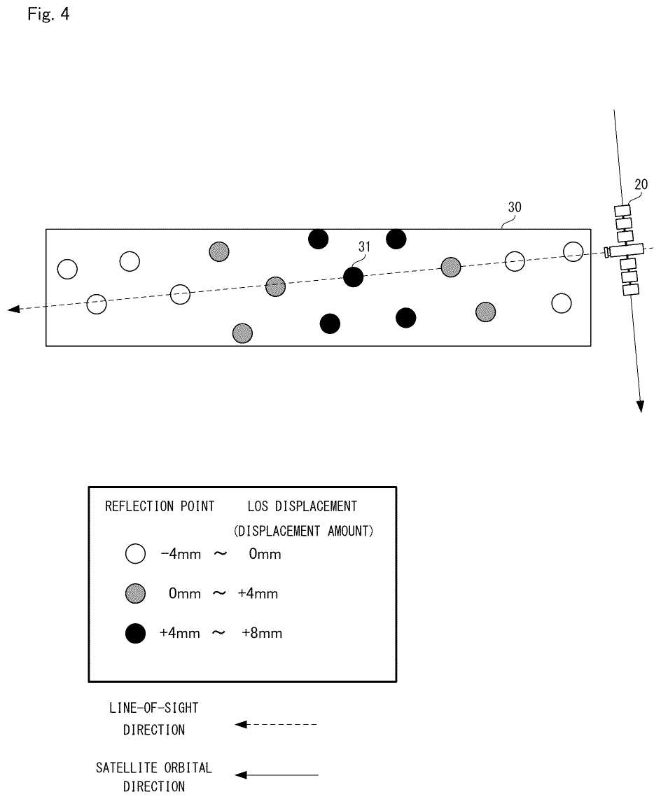

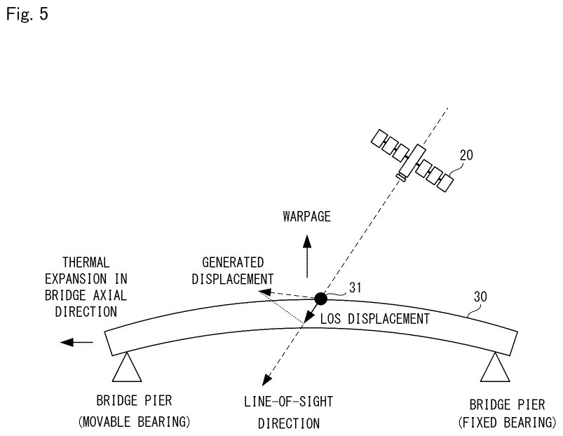

Next, a configuration and a function of the first example embodiment will be specifically described with reference to FIGS. 2 to 5. FIG. 2 is a configuration diagram specifically illustrating a configuration of an example of the information processing apparatus. FIG. 3 is a diagram illustrating an example of the object. FIG. 4 is a diagram illustrating displacement of the object at a reflection point relevant to irradiation direction phase difference data. FIG. 5 is a diagram illustrating an example of irradiation direction displacement (LOS displacement) measured by an artificial satellite.

As illustrated in FIG. 2, the information processing apparatus 10 includes a displacement amount estimation unit 15, a parameter update unit 16, and a specific displacement amount estimation unit 17 in addition to the data acquisition unit 11, the first phase difference calculation unit 12, the second phase difference calculation unit 13, and the parameter evaluation unit 14 described above.

As illustrated in FIG. 2, in the example embodiment, it is assumed that the flying object is an artificial satellite 20 and the object is a bridge 30. As illustrated in FIG. 3, it is assumed that a first direction of the bridge 30 which is an object is a bridge axis direction (x direction) of the bridge 30, and a second direction is a vertical direction (z direction). Further, the bridge 30 illustrated in FIG. 3 is a water pipe bridge for conveying water. Unlike a normal bridge, a water pipe bridge structurally generates a temperature difference between a water pipe portion and an arch portion. In FIG. 3, the temperature of the water pipe portion is denoted by T₁, and the temperature of the arch portion is denoted by T₂.

As illustrated in FIG. 4, the irradiation direction phase difference data created based on the satellite image transmitted from the artificial satellite 20 is data relevant to the LOS displacement for each reflection point 31 analyzed by satellite SAR. In FIG. 3, a broken arrow indicates the irradiation direction of the radio wave from the artificial satellite 20, and a solid arrow indicates the orbit of the artificial satellite 20.

As illustrated in FIG. 5, the LOS displacement is displacement in the line-of-sight direction (irradiation direction) of the satellite. On the other hand, the obtained displacement is displacement in the bridge axis direction and displacement in the vertical direction of the bridge 30. In FIG. 5, the bridge 30 is modeled. In the example of FIG. 5, the bridge 30 is deformed by thermal expansion or contraction, thereby causing displacement.

The artificial satellite 20 transmits a satellite image to the base at a set date and time or periodically. The satellite image received at the base is processed into data representing a phase difference of pixels in an observation day in a radio wave irradiation direction of the satellite, and is accumulated in the database 21 as illustrated in FIG. 2. The irradiation direction phase difference data has an observation time, and the accumulated irradiation direction phase difference data is time-series data.

In the example embodiment, the data acquisition unit 11 acquires irradiation direction phase difference data at each reflection point of the bridge 30 from database 21. As described above, since the irradiation direction displacement data is acquired for each reflection point, processing by the first phase difference calculation unit 12, the second phase difference calculation unit 13, and the displacement amount estimation unit 15 described later is performed for each reflection point.

In the database 21, the temperature T₁ of the water pipe portion and the temperature T₂ of the arch portion of the bridge 30 are stored in chronological order. Therefore, the data acquisition unit 11 also acquires time-series data of the temperature T₁ of the water pipe portion and the temperature T₂ of the arch portion. In addition, the database 21 also stores data required for estimation processing in the displacement amount estimation unit 15 and the specific displacement amount estimation unit 17 described later. The data acquisition unit also acquires data necessary for the estimation processing in the displacement amount estimation unit 15 and specific displacement amount estimation unit 17.

The first phase difference calculation unit 12 acquires, from the data acquisition unit 11, time-series data of the temperature T₁ of the water pipe portion illustrated in FIG. 3 as a time-series temperature change in the bridge 30, and calculates a temperature change ΔT₁. Using the time-series temperature change ΔT₁ of the bridge 30 and a time-series temperature difference parameter kₓ, the first phase difference calculation unit 12 calculates a phase difference Δφₓ in the bridge axis direction of the bridge 30 by the following Expression 2. Furthermore, the first phase difference calculation unit 12 calculates a value (first irradiation direction projection value) Δφₓₚᵣₒ when the phase difference Δφₓ is projected in the irradiation direction by the following Expression 3. A represents a wavelength of a radio wave emitted from a satellite.

$$Δ {ϕ}_{x} = {k}_{x} Δ {T}_{1} \qquad [ Math . 2 ]$$

$${Δϕ}_{x p r o} = \frac{4 π}{λ} {k}_{x} Δ {T}_{1} \qquad [ Math . 3 ]$$

The second phase difference calculation unit 13 acquires the time-series data of the temperature T₁ of the water pipe portion and the temperature T₂ of the arch portion from the data acquisition unit 11, and calculates “ΔT₂−ΔT₁” as the spatial temperature difference generated in the vertical direction of the bridge 30. Using “ΔT₂−ΔT₁” and the spatial temperature difference parameter k_{z}, the second phase difference calculation unit 13 calculates a phase difference Δφ_{z} of the bridge 30 in the vertical direction by the following Expression 4. Furthermore, the second phase difference calculation unit 13 calculates a value (second irradiation direction projection value) Δφ_{zpro} when the phase difference Δφ_{z} is projected in the irradiation direction by the following Expression 5.

$$Δ {ϕ}_{z} = {k}_{z} ( Δ {T}_{2} - Δ {T}_{1} ) \qquad [ Math . 4 ]$$

$$Δ {ϕ}_{z p r o} = \frac{4 π}{λ} {k}_{z} ( Δ {T}_{2} - Δ {T}_{1} ) \qquad [ Math . 5 ]$$

The displacement amount estimation unit 15 estimates a displacement amount (estimated displacement amount Δφₕₐₜ) in the irradiation direction of the bridge using the first irradiation direction projection value Δφₓₚᵣₒ and the second irradiation direction projection value Δφ_{zpro}. Specifically, the displacement amount estimation unit 15 estimates the displacement amount (estimated displacement amount Δφₕₐₜ) in the irradiation direction using the following Expression 6.

$$= \frac{4 π}{λ} {k}_{x} Δ {T}_{1} + \frac{4 π}{λ} {k}_{z} ( Δ {T}_{2} - Δ {T}_{1} ) + \frac{4 π}{λ} {v}_{LOS} Δ t + \frac{4 π}{λ} \frac{B}{{R}_{0} sin θ} Δ h \qquad [ Math . 6 ]$$

In the above Expression 6, vₗₒₛ is a parameter proportional to the elapsed time Δt after the object is irradiated with the radio wave, similarly to Expression 1 described in the background art section. B represents a baseline length (an error in the orbit of the satellite), and R₀ represents a strut range, that is, a distance between the satellite and the object, similarly to the above Expression 1. Similarly to Expression 1 above, θ represents an angle formed by a line-of-sight direction of the artificial satellite and a vertical direction on the zx plane, and Δₕ represents an error between digital elevation model (DEM) data and an actual ground surface height.

The parameter evaluation unit 14 calculates the difference α by subtracting the displacement amount Δφ indicated by the irradiation direction phase difference data from the displacement amount (estimated displacement amount Δφhat) estimated by the displacement amount estimation unit 15 as expressed in the following Expression 7.

$$α = Δϕ - \qquad [ Math . 7 ]$$

The parameter evaluation unit 14 uses the calculated difference α to calculate an evaluation value that increases as the difference α increases. Specifically, the parameter evaluation unit 14 calculates the evaluation value E using, for example, the following Expression 8.

$$E = {\sum }_{t = 1}^{{N}_{t}} {e}^{i ( Δ ϕ ( t ) - ( t ) )} \qquad [ Math . 8 ]$$

The parameter update unit 16 updates the value of the time-series temperature difference parameter kₓ and the value of the spatial temperature difference parameter k_{z} so that the evaluation value E becomes small. Examples of a parameter update method include a particle swarm optimization method (PSO) and a metropolitan hasting method in Markov chain Monte Carlo (MCMC).

When the update is performed by the parameter update unit 16, the above-described processes in the first phase difference calculation unit 12, the second phase difference calculation unit 13, the displacement amount estimation unit 15, and the parameter evaluation unit 14 are performed. Thereafter, the parameter update unit 16 updates the value of the time-series temperature difference parameter kₓ and the value of the spatial temperature difference parameter k_{z} again. Such a series of processes is executed a plurality of times, and the time-series temperature difference parameter kₓ and the spatial temperature difference parameter k_{z} have appropriate values.

The specific displacement amount estimation unit 17 estimates a displacement amount dx of the bridge 30 in the bridge axis direction and a displacement amount dz of the bridge 30 in the vertical direction using the time-series temperature difference parameter kₓ and the spatial temperature difference parameter k_{z} updated a plurality of times by the parameter update unit 16. The specific displacement amount estimation unit 17 outputs the estimated displacement amounts dx and dz to the terminal device 40 of the user.

Specifically, the specific displacement amount estimation unit 17 can estimate the displacement amounts dx and dz using displacement analysis (2.5 dimensional analysis) disclosed in the following reference document. The specific displacement amount estimation unit 17 can also estimate the displacement amounts dx and dz by modeling the displacement amounts dx and dz.

### REFERENCE

Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000.

### Apparatus Operation

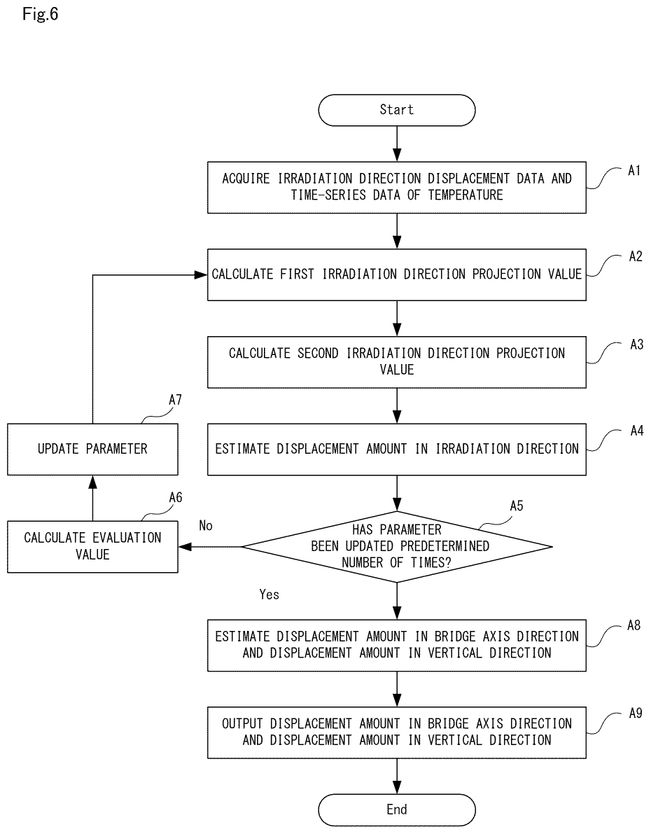

Next, an example of the operation of the information processing apparatus 10 will be described with reference to FIG. 6. FIG. 6 is a flowchart illustrating an example of the operation of the information processing apparatus. In the following description, FIGS. 1 to 5 will be appropriately referred to. In the example embodiment, the information processing method is performed by operating the information processing apparatus 10. Therefore, the description of the information processing method in the example embodiment is replaced with the following description of the operation of the information processing apparatus 10.

As illustrated in FIG. 6, first, the data acquisition unit 11 acquires irradiation direction displacement data at each reflection point of the bridge 30 and time-series data of the temperature of the bridge 30 from the database 21 (step A1).

Specifically, the time-series data of the temperature of the bridge 30 is time-series data of the temperature T₁ of the water pipe portion and time-series data of the temperature T₂ of the arch portion. The data acquisition unit also acquires, from database 21, data necessary for the estimation processing in the displacement amount estimation unit 15 and specific displacement amount estimation unit 17.

Next, the first phase difference calculation unit 12 calculates a phase difference in the bridge axis direction using the time-series temperature change and the time-series temperature difference parameter on the bridge 30, projects the calculated phase difference in the bridge axis direction on the irradiation direction, and calculates a first irradiation direction projection value (step A2).

Specifically, in step A2, the first phase difference calculation unit 12 first acquires, from the data acquisition unit 11, time-series data of the temperature T₁ of the water pipe portion illustrated in FIG. 3 as a time-series temperature change on the bridge 30, and calculates a temperature change ΔT₁. Then, the first phase difference calculation unit 12 calculates the phase difference Δφₓ in the bridge axis direction of the bridge 30 by the above Expression 2 using the time-series temperature change ΔT₁ of the bridge 30 and the time-series temperature difference parameter kₓ. Furthermore, the first phase difference calculation unit 12 calculates the first irradiation direction projection value Δφₓₚᵣₒ by the above Expression 3.

Next, the second phase difference calculation unit 13 calculates a phase difference in the vertical direction using the spatial temperature difference generated in the vertical direction of the bridge 30 and the spatial temperature difference parameter, projects the calculated phase difference in the vertical direction on the irradiation direction, and calculates a second irradiation direction projection value (step A3).

Specifically, in step A3, the second phase difference calculation unit 13 first acquires the time-series data of the temperature T₁ of the water pipe portion and the temperature T₂ of the arch portion from the data acquisition unit 11, and calculates “ΔT₂−ΔT₁” as the spatial temperature difference generated in the vertical direction of the bridge 30. Using “ΔT₂−ΔT₁” and the spatial temperature difference parameter k_{z}, the second phase difference calculation unit 13 calculates a phase difference Δφ_{z} of the bridge 30 in the vertical direction by the above Expression 4. Furthermore, the second phase difference calculation unit 13 calculates the second irradiation direction projection value Δφ_{zpro} by the above Expression 5.

Next, the displacement amount estimation unit 15 estimates the displacement amount in the irradiation direction of the bridge using the first irradiation direction projection value and the second irradiation direction projection value (step A4). Specifically, the displacement amount estimation unit 15 applies first irradiation direction projection value Δφₓₚᵣₒ and second irradiation direction projection value Δφ_{zpro} to the above Expression 6 to estimate the displacement amount (estimated displacement amount Δφhat) in the irradiation direction.

Next, the parameter evaluation unit 14 determines whether the time-series temperature difference parameter kₓ and the spatial temperature difference parameter k_{z} have been updated a predetermined number of times (step A5).

As a result of the determination in step A5, when the update has not been performed the predetermined number of times (step A5: No), the parameter evaluation unit 14 calculates an evaluation value indicating a difference between the displacement amount estimated in step A4 and the displacement amount indicated by the irradiation direction phase difference data acquired in step A1 (step A6).

Specifically, in step A6, the parameter evaluation unit 14 calculates the difference α by subtracting the displacement amount Δφ indicated by the irradiation direction phase difference data from the estimated displacement amount (estimated displacement amount Δφhat) as expressed in the above Expression 7. Then, the parameter evaluation unit 14 calculates an evaluation value E by applying the calculated difference α to the above Expression 7.

Next, the parameter update unit 16 updates the value of the time-series temperature difference parameter and the value of the spatial temperature difference parameter so that the evaluation value becomes small (step A7). When step A7 is executed, steps A2 to A5 are executed again using the updated parameters.

On the other hand, as a result of the determination in step A5, when the update has been performed the predetermined number of times (step A5: Yes), the specific displacement amount estimation unit 17 estimates the displacement amount dx of the bridge 30 in the bridge axis direction and the displacement amount dz of the bridge 30 in the vertical direction using the time-series temperature difference parameter and the spatial temperature difference parameter updated the predetermined number of times (step A8).

Thereafter, the specific displacement amount estimation unit 17 outputs the displacement amounts dx and dz estimated in step A8 to the terminal device 40 of the user (step A9).

### Effects of Example Embodiment

In this manner, the information processing apparatus 10 can obtain the time-series temperature difference parameter and the spatial temperature difference parameter with high accuracy. Therefore, according to the information processing apparatus 10, even when the temperature distribution in the vertical direction on the bridge 30 is not uniform, the displacement amount in the bridge axis direction and the displacement amount in the vertical direction of the bridge 30 can be calculated with high accuracy.

In the above-described example, only two temperatures are used as the temperature, but the present disclosure is not limited thereto. Three or more temperatures may be used, in which case two or more spatial temperature difference parameters are set.

Furthermore, in the example described above, a case where irradiation direction displacement difference data generated by radio waves emitted from an artificial satellite is used is illustrated, but the data is not limited to the irradiation direction displacement data in the present disclosure. The data may be any data indicating an observed displacement amount, and may be, for example, data indicating a displacement amount detected from a target image.

### Program

As a program in the example embodiment, a program that causes a computer to execute steps A1 to A9 illustrated in FIG. 6 may be adopted. When the program is installed and executed in the computer, the information processing apparatus 10 and the information processing method can be achieved. In this case, the processor of the computer functions as the data acquisition unit 11, the first phase difference calculation unit 12, the second phase difference calculation unit 13, the parameter evaluation unit 14, the displacement amount estimation unit 15, the parameter update unit 16, and the specific displacement amount estimation unit 17, and performs processing. Examples of the computer include a smartphone and a tablet terminal device in addition to a general-purpose PC and a server computer.

The program in the example embodiment may be executed by a computer system constructed by a plurality of computers. In this case, for example, each computer may function as any of the data acquisition unit 11, the first phase difference calculation unit 12, the second phase difference calculation unit 13, the parameter evaluation unit 14, the displacement amount estimation unit 15, the parameter update unit 16, and the specific displacement amount estimation unit 17.

### Physical Configuration

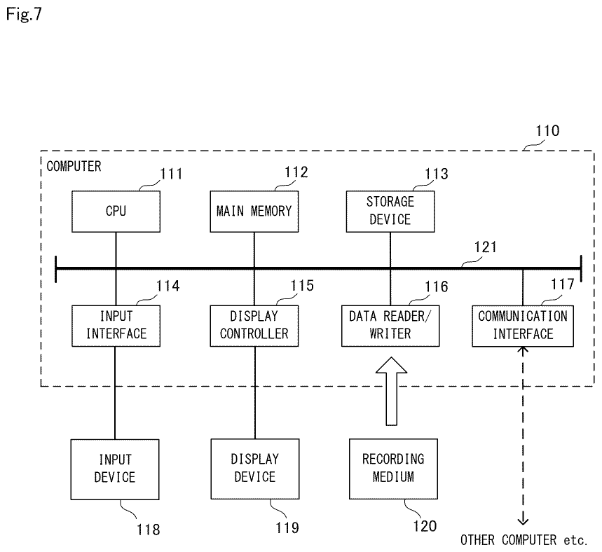

Here, a computer that achieves an information processing apparatus 10 by executing the programs in the example embodiments will be described with reference to FIG. 7. FIG. 7 is a block diagram illustrating an example of the computer that achieves the information processing apparatus.

As illustrated in FIG. 7, computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a Compact Flash (CF) (registered trademark) and a Secure Digital (SD), a magnetic recording medium such as a flexible disk, and an optical recording medium such as a compact disk read only memory (CD-ROM).

The information processing apparatus 10 can also be achieved by using hardware related to each unit, for example, an electronic circuit, instead of the computer in which the program is installed. Furthermore, a part of the information processing apparatus 10 may be achieved by a program, and the remaining part may be achieved by hardware. In the example embodiment, the computer is not limited to the computer illustrated in FIG. 7.

Some or all of the above-described example embodiments can be expressed by (Supplementary Note 1) to (Supplementary Note 12) described below, but are not limited to the following description.

### Supplementary Note 1

An information processing apparatus including:
a data acquisition unit that acquires irradiation direction phase difference data indicating a displacement amount in an irradiation direction of an object, the displacement amount being generated by irradiation of the object with a radio wave from a flying object;
a first phase difference calculation unit that calculates a phase difference in a first direction in the object by using a time-series temperature change in the object and a time-series temperature difference parameter, and further calculates a value when the calculated phase difference in the first direction is projected in the irradiation direction;
a second phase difference calculation unit that calculates a phase difference in the second direction by using a spatial temperature difference generated in a second direction different from the first direction in the object and a spatial temperature difference parameter, and calculates a value when the calculated phase difference in the second direction is projected in the irradiation direction; and
a parameter evaluation unit that evaluates the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

### Supplementary Note 2

The information processing apparatus according to Supplementary Note 1, further including a parameter update unit that updates values of the time-series temperature difference parameter and the spatial temperature difference parameter using a result of the evaluation.

### Supplementary Note 3

The information processing apparatus according to Supplementary Note 2, in which
the parameter evaluation unit calculates an evaluation value that increases as the difference increases, and
the parameter update unit updates values of the time-series temperature difference parameter and the spatial temperature difference parameter in such a way that the evaluation value decreases.

### Supplementary Note 4

The information processing apparatus according to Supplementary Note 1, in which
the object is a bridge,
the first direction is a bridge axis direction, and
the second direction is a vertical direction.

### Supplementary Note 5

An information processing method including:
a data acquisition step of acquiring irradiation direction phase difference data indicating a displacement amount in an irradiation direction of an object, the displacement amount being generated by irradiation of the object with a radio wave from a flying object;
a first phase difference calculation step of calculating a phase difference in a first direction in the object by using a time-series temperature change in the object and a time-series temperature difference parameter, and further calculating a value when the calculated phase difference in the first direction is projected in the irradiation direction;
a second phase difference calculation step of calculating a phase difference in the second direction by using a spatial temperature difference generated in a second direction different from the first direction in the object and a spatial temperature difference parameter, and calculating a value when the calculated phase difference in the second direction is projected in the irradiation direction; and
a parameter evaluation step of evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

### Supplementary Note 6

The information processing method according to Supplementary Note 5, further including a parameter update step of updating values of the time-series temperature difference parameter and the spatial temperature difference parameter using a result of the evaluation.

### Supplementary Note 7

The information processing method according to Supplementary Note 6, further including:
calculating, in the parameter evaluation step, an evaluation value that increases as the difference increases, and
updating, in the parameter update step, values of the time-series temperature difference parameter and the spatial temperature difference parameter in such a way that the evaluation value decreases.

### Supplementary Note 8

The information processing method according to Supplementary Note 5, in which
the object is a bridge,
the first direction is a bridge axis direction, and
the second direction is a vertical direction.

### Supplementary Note 9

A computer-readable recording medium having recorded therein a program containing commands for causing a computer to execute:
a data acquisition step of acquiring irradiation direction phase difference data indicating a displacement amount in an irradiation direction of an object, the displacement amount being generated by irradiation of the object with a radio wave from a flying object;
a first phase difference calculation step of calculating a phase difference in a first direction in the object by using a time-series temperature change in the object and a time-series temperature difference parameter, and further calculating a value when the calculated phase difference in the first direction is projected in the irradiation direction;
a second phase difference calculation step of calculating a phase difference in the second direction by using a spatial temperature difference generated in a second direction different from the first direction in the object and a spatial temperature difference parameter, and calculating a value when the calculated phase difference in the second direction is projected in the irradiation direction; and
a parameter evaluation step of evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

### Supplementary Note 10

The computer-readable recording medium according to Supplementary Note 9, in which the program contains a command for causing the computer to execute a parameter update step of updating values of the time-series temperature difference parameter and the spatial temperature difference parameter using a result of the evaluation.

### Supplementary Note 11

The computer-readable recording medium according to Supplementary Note 10, further including:
calculating, in the parameter evaluation step, an evaluation value that increases as the difference increases, and
updating, in the parameter update step, values of the time-series temperature difference parameter and the spatial temperature difference parameter in such a way that the evaluation value decreases.

### Supplementary Note 12

The computer-readable recording medium according to Supplementary Note 9, in which
the object is a bridge,
the first direction is a bridge axis direction, and
the second direction is a vertical direction.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

As described above, according to the present disclosure, it is possible to improve the calculation accuracy of the displacement in the object. The present disclosure is useful, for example, in a system that analyzes an infrastructure.

1. An information processing apparatus comprising:
at least one memory storing instructions; and
at least one processor configured to execute the instructions to:
acquire irradiation direction phase difference data indicating a displacement amount in an irradiation direction of an object, the displacement amount being generated by irradiation of the object with a radio wave from a flying object;
calculate a phase difference in a first direction in the object by using a time-series temperature change in the object and a time-series temperature difference parameter, and further calculate a value when the calculated phase difference in the first direction is projected in the irradiation direction;
calculate a phase difference in the second direction by using a spatial temperature difference generated in a second direction different from the first direction in the object and a spatial temperature difference parameter, and calculate a value when the calculated phase difference in the second direction is projected in the irradiation direction; and
evaluate the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

2. The information processing apparatus according to claim 1, wherein,
at least one processor further updates values of the time-series temperature difference parameter and the spatial temperature difference parameter using a result of the evaluation.

3. The information processing apparatus according to claim 2, wherein
at least one processor calculates an evaluation value that increases as the difference increases, and
updates values of the time-series temperature difference parameter and the spatial temperature difference parameter in such a way that the evaluation value decreases.

4. The information processing apparatus according to claim 1, wherein
the object is a bridge,
the first direction is a bridge axis direction, and
the second direction is a vertical direction.

5. An information processing method that is executed by a computer, the method comprising:
acquiring irradiation direction phase difference data indicating a displacement amount in an irradiation direction of an object, the displacement amount being generated by irradiation of the object with a radio wave from a flying object;
calculating a phase difference in a first direction in the object by using a time-series temperature change in the object and a time-series temperature difference parameter, and further calculating a value when the calculated phase difference in the first direction is projected in the irradiation direction;
calculating a phase difference in the second direction by using a spatial temperature difference generated in a second direction different from the first direction in the object and a spatial temperature difference parameter, and calculating a value when the calculated phase difference in the second direction is projected in the irradiation direction; and
evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

6. The information processing method according to claim 5, further comprising updating values of the time-series temperature difference parameter and the spatial temperature difference parameter using a result of the evaluation.

7. The information processing method according to claim 6, further comprising:
calculating, in the evaluating of the parameter, an evaluation value that increases as the difference increases, and
updating, in the updating of the parameter, values of the time-series temperature difference parameter and the spatial temperature difference parameter in such a way that the evaluation value decreases.

8. The information processing method according to claim 5, wherein
the object is a bridge, and
the first direction is a bridge axis direction, and
the second direction is a vertical direction.

9. A non-transitory computer-readable recording medium having recorded therein a program for causing a computer to execute:
acquiring irradiation direction phase difference data indicating a displacement amount in an irradiation direction of an object, the displacement amount being generated by irradiation of the object with a radio wave from a flying object;
calculating a phase difference in a first direction in the object by using a time-series temperature change in the object and a time-series temperature difference parameter, and further calculating a value when the calculated phase difference in the first direction is projected in the irradiation direction;
calculating a phase difference in the second direction by using a spatial temperature difference generated in a second direction different from the first direction in the object and a spatial temperature difference parameter, and calculating a value when the calculated phase difference in the second direction is projected in the irradiation direction; and
evaluating the time-series temperature difference parameter and the spatial temperature difference parameter by using a difference obtained by subtracting a displacement amount indicated by the irradiation direction phase difference data from a displacement amount estimated by using a value when the phase difference in the first direction is projected in the irradiation direction and a value when the phase difference in the second direction is projected in the irradiation direction.

10. The non-transitory computer-readable recording medium according to claim 9, wherein the program further causes the computer to execute updating values of the time-series temperature difference parameter and the spatial temperature difference parameter using a result of the evaluation.

11. The non-transitory computer-readable recording medium according to claim 10, wherein the program further causes the computer to execute:
calculating, in the evaluating of the parameter, an evaluation value that increases as the difference increases, and
updating, in the updating of the parameter, values of the time-series temperature difference parameter and the spatial temperature difference parameter in such a way that the evaluation value decreases.

12. The non-transitory computer-readable recording medium according to claim 9, wherein
the object is a bridge,
the first direction is a bridge axis direction, and
the second direction is a vertical direction.
